(19) United States
(12) Patent Application Publication
(10) Pub. No.: US 2003/0066745 A1
(43) Pub. Date: Apr. 10, 2003

(54) Repairable short-path still

(76) Inventor: Donald D. Miller, Santa Cruz, CA (US)

Correspondence Address: TIM W. WAN, UNIVERSITY OF CALIFORNIA, O.T.T., 1111 FRANKLIN STREET, 5TH FLOR, OAKLAND, CA, 94607, US

(21) Appl. No.: 09/972,095

(22) Filed: Oct. 5, 2001

(51) Int. Cl. B01D 3/10; B01D 3/12

(52) U.S. Cl. 203/91; 203/100; 202/205; 202/160

(57) ABSTRACT

A repairable short-path still is manufactured by forming the still body containing the cooling jacket and the vacuum adapter with two ring seals.

### TECHNICAL FIELD

This invention relates generally to the manufacturing of a chemistry glass apparatus, and more particularly to an apparatus for and a method to manufacture a repairable short-path still.

### BACKGROUND OF THE INVENTION

Components of Existing State of the Art Short-Path Still

The components of an existing state of the art short-path still are illustrated in FIG. 1.

The existing state of the art short-path still consists of (1) a still body and (2) a thermometer well/still pot adapter.

There is one ring seal 2 located between the still body and the thermometer well/still pot adapter 4. A ring seal is a seal that seals off two different glass compartments. A ring seal is made from a tube, which is inserted into the center of the still body. This tube is called the center tube 6.

The still body further consists of (a) a cooling jacket 8 and (b) a vacuum adapter 10.

A center tube goes through the center of the cooling jacket and the vacuum adapter. There is one ring seal 12 located between the cooling jacket and the vacuum adapter.

Manufacturing Process

1. Cut a glass tube 6 (6 mm or 10 mm in diameter) to the desired length.

2. Make a ring seal 12 at the middle of the glass tube.

3. Insert the glass tube, which functions as a center tube, into a larger glass tube.

4. Mold the larger glass tube into a still body consisting of a cooling jacket 8 and a vacuum adapter 10, with the center tube going through the cooling jacket and the vacuum adapter. Position the ring seal 12 at the middle of the center tube in such a way that the seal ring seals off the cooling jacket from the vacuum adapter.

5. Make the two hose connections 14 for the cooling jacket and the one hose connection 16 for the vacuum adapter.

6. Make one ring seal 2 on the left end of the center tube. Pull down the left end of the center tube and connect it to the thermometer well/still pot adapter 4.

7. On the right end of the vacuum adapter, put in a 14/20 millimeter ground glass joint 18, which will be used to connect the apparatus to the coolant collection reservoir flask.

8. Mold another large tube into the thermometer well/still pot adapter 4.

9. Put on a 14/20 millimeter ground glass joint 20 at the bottom end of the still pot adapter.

10. Connect the still body to the thermometer well/still pot adapter.

11. Install a support rod 22 in the manner illustrated by FIG. 1.

Breakage

In the existing state of the art short-path still, breakage often occurs when the coolant collection reservoir flask is being removed from the 14/20 millimeter glass joint. The breakage can happen anywhere from the outlet tapered tip 18 of the center tube to the ring seal 12.

Repair

To repair the breakage in the existing state of the art short-path still, the still body is separated from the thermometer well/still pot adapter by cutting away the support rod 22 and at the ring seal 2 on the left end of the center tube. The entire still will have to be remanufactured from scratch. This is very labor intensive.

### SUMMARY OF THE INVENTION

In this invention, the still body of the repairable short-path still has two ring seals, as opposed to the one ring seal found in the existing state of the art short-path still body. Please see FIG. 2.

In this invention, the cooling jacket has one ring seal 24, and the vacuum adapter has one ring seal 26.

There is a small area 28 where the center tube ring seal of the cooling jacket and the center tube ring seal of the vacuum adapter meet. When the center tube breaks at the vacuum adapter ring seal, which constitutes about 90% of the breakage, the vacuum adapter 10 can be separated from the cooling jacket 8 by cutting away at the small area 28 between the vacuum adapter and the cooling jacket.

The broken center tube 6 inside the vacuum adapter can then be replaced with a new center tube and a new ring seal 26. Subsequently, the vacuum adapter of the still body is resealed by heating both the cooling jacket ring seal and the vacuum adapter ring seal simultaneously. This repair work takes about fifteen minutes. This is a dramatic contrast to the existing short-path still, where it takes about ninety minutes to repair breakage by remanufacturing the entire still body.

Currently, when a breakage occurs in the existing state of the art short-path still, the entire apparatus is discarded rather than repaired. After many attempts at repairing the existing state of the art short-path still, it dawned on the inventor to create a repairable short-path still by separating the cooling jacket of a still body intact from a vacuum adapter of a still body for repairs, by forming the still body containing the cooling jacket and the vacuum adapter with two ring seals 24, 26. The repairs are performed by cutting away at an area 28 between the vacuum adapter ring seal 26 and the cooling jacket ring seal 24.

### BRIEF DESCRIPTION OF THE DRAWINGS

A more complete understanding of the present invention may be accomplished by reviewing the “Background of the Invention” section and the “Detailed Description” section in conjunction with the accompanying Drawings, wherein:

FIG. 1 is a schematic illustration of an existing state of the art short-path still, and

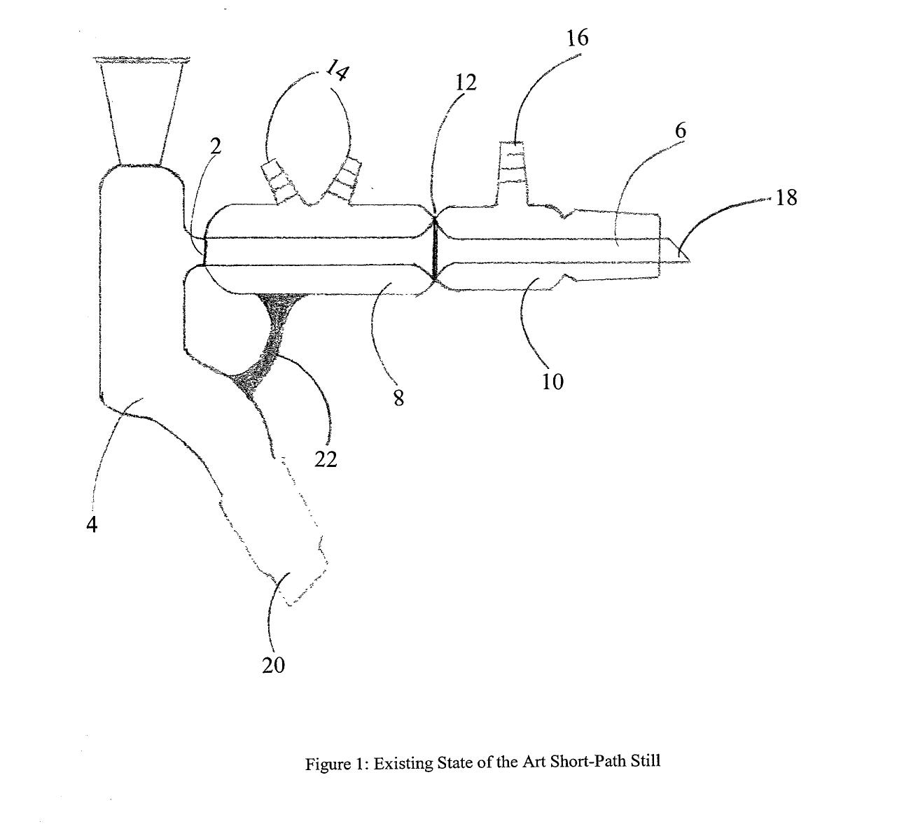

FIG. 2 is a schematic illustration of the invention—a repairable short-path still.

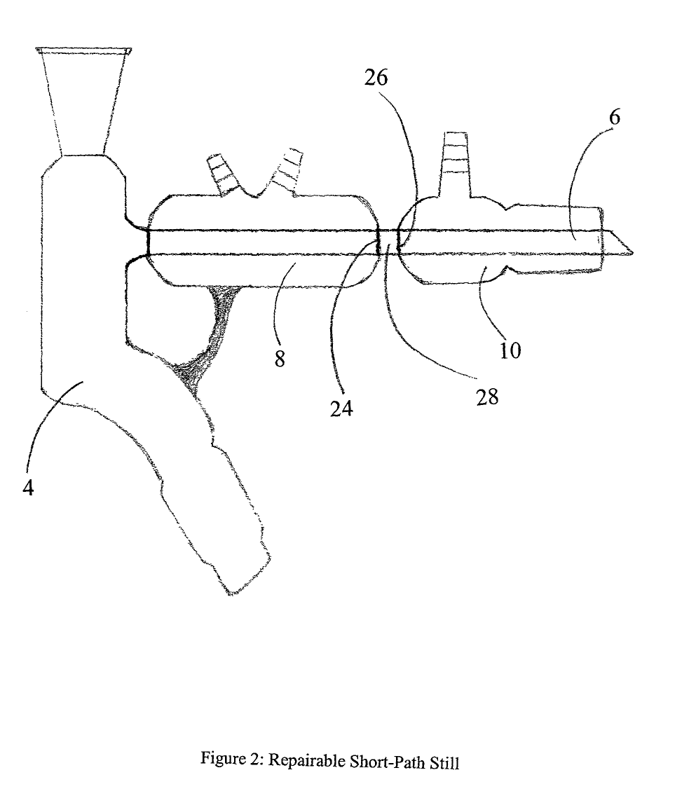

### DETAILED DESCRIPTION

1. Make the repairable short-path still in three sections as described above under “Manufacturing Process”: (a) the thermometer well and still pot adapter 4 in one section; (b) the cooling jacket 8 containing the center tube in one section; and (c) the vacuum adapter 10 containing the center tube in one section.

2. Secure the vacuum adapter component onto one end of a lathe.

3. Secure the cooling jacket component onto the other end of a lathe.

4. Rotate the lather, and align the ring seal 24 of the center tube of the vacuum adapter with the ring seal 26 of the center tube of the cooling jacket.

5. Heat the glass near the two ring seals and connect the two components by using a carbon rod to push the heated glass onto the ring seals.

6. Connect the still body 8, 10 to the thermometer well/still pot adapter 4 as described above under “Manufacturing Process”.

1. A repairable short-path still comprising:
(a) a vacuum adapter containing a center tube,
(b) a cooling jacket containing a center tube,
(c) a thermometer well/still pot adapter, where
the vacuum adapter center tube is connected to the cooling jacket center tube by two ring seals, and the cooling jacket is connected to the thermometer well/still pot adapter by one ring seal.

2. The repairable short-path still of claim 1 wherein the center tube is 6 millimeters in diameter.

3. The repairable short-path still of claim 1 wherein the center tube is 10 millimeters in diameter.

4. A method for separating a cooling jacket of a still body intact from a vacuum adapter of a still body for repairs by cutting away at an area between the vacuum adapter ring seal and the cooling jacket ring seal.
